(19) United States
(12) Patent Application Publication
(10) Pub. No.: US 2024/0370872 A1
(43) Pub. Date: Nov. 7, 2024

(54) Virtual Goods Merchant Verification

(71) Applicant: Google LLC, Mountain View, CA (US)

(72) Inventors: Morgan Kennedy, San Francisco, CA (US); Nasheet Islam, Oakland, CA (US)

(21) Appl. No.: 18/142,912

(22) Filed: May 3, 2023

(51) Int. Cl. G06Q 20/40; G06Q 20/36

(52) U.S. Cl. CPC G06Q 20/4016; G06Q 20/3674; G06Q 2220/00

(57) ABSTRACT

The technology is generally directed to providing an indication signifying whether a merchant associated with a digital component has been verified. The digital component may be, for example, an advertisement for the sale of a virtual good, such as a non-fungible token (“NFT”) or other digital asset. The indication may be an indicator, such as an icon, conspicuously positioned on a portion of the digital component to alert users that the merchant associated with the digital component has been verified and/or the virtual good within the digital component has been verified. In some examples, the indication may alert users that the merchant associated with the digital component is the owner of the virtual good. The indication may be displayed if a threshold number of criteria are met, including whether the merchant has transacted with decoys, whether the transactions of the merchant utilized deceitful contracts.

### BACKGROUND

Virtual goods, such as non-fungible tokens, are typically offered for sale or re-sale from individual creators, collectors, or a marketplace. However, the merchant offering the virtual good for sale is typically not vetted, leaving it unclear to users whether the merchant is safe to transact with. Moreover, the virtual good itself is typically not vetted to ensure authenticity and whether it is safe to enter a transaction for the virtual good. This can lead to buyers entering into unsafe, or deceitful, transactions with the merchant or to the purchase of a potentially fake virtual good.

### BRIEF SUMMARY

The technology is generally directed to providing an indication signifying whether a merchant and/or virtual good associated with a digital component has been verified. The indication may indicate whether the merchant is safe to transact with, whether the virtual good is safe to purchase, whether the virtual good is legitimate, e.g., not a fake, etc. The digital component may be an advertisement for the sale of the virtual good, which may be a non-fungible token (“NFT”) or other digital asset. The indication may be an indicator conspicuously positioned on a portion of the digital component to alert users that the merchant associated with the virtual good and/or the virtual good itself has been verified. The verification process may ensure that the merchant and/or virtual good is safe to transact with.

The indication may only be displayed after certain criteria pertaining to the merchant and/or virtual good have been met. For example, when verifying the merchant, the criteria may include whether the merchant has transacted with any known decoys, whether the merchant has utilized deceitful contracts, or the like. When verifying the virtual good, the criteria may include, for example, whether any party associated with a transaction for the virtual good is a known decoy, whether any transaction associated with the virtual good utilized deceitful contracts, or the like. If each criteria is negative, the merchant and/or virtual good may be verified. According to some examples, the merchant and/or virtual good may fulfill a threshold number of criteria before being verified. In another example, the merchant and/or virtual good may fulfill all the criteria before being verified.

One aspect of the disclosure is directed to a method, comprising receiving, by one or more processors, a submission of a digital component, receiving, by the one or more processors from a wallet owner, authorization to access a transaction history of a digital wallet, wherein the wallet owner is associated with the digital component and determining, by the one or more processors based on the transaction history, factors. The factors may comprise whether a party to one or more transactions of the transaction history is a previously identified decoy, and whether one or more transactions of the transaction history utilized deceitful contracts. The method may further comprise associating, by the one or more processors, an indicator with the digital component based on the factors. According to some examples, the indicator may be associated with the digital component if each of the factors is negative.

The method may further comprise providing, by the one or more processors, the digital component and associated indicator for output.

When determining whether the one or more transactions of the transaction history is the previously identified decoy, the method may further comprise identifying, by the one or more processors, an identity of a party to the respective transaction other than the wallet owner, and determining, based on the identified identify of the party, whether the party corresponds to one or more previously identified decoys.

When determining whether the one or more transactions utilized deceitful contracts, the method may further comprise determining, by the one or more processors, one or more types of contracts, and comparing, by the one or more processors, the determined one or more types of contracts to smart contracts, wherein when a type of contract does not correspond to a smart contract, the type of contract is a deceitful contract.

The method may further comprise verifying, by the one or more processors based on the transaction history, ownership of the digital component. Verifying ownership of the ownership digital component may include identifying, by the one or more processors based on the transaction history, an owner of the digital component, and comparing, by the one or more processors, the identified owner and the wallet owner.

The digital component may be an advertisement related to a non-fungible token. The indicator may signify that the wallet owner has been verified.

Another aspect of the disclosure is directed to a system comprising one or more processors. The one or more processors may be configured to receive a submission of a digital component, receive, from a wallet owner, authorization to access a transaction history of a digital wallet, wherein the wallet owner is associated with the digital component; and determine, based on the transaction history, factors. The factors may comprise whether a party to one or more transactions of the transaction history is a previously identified decoy, and whether one or more transactions of the transaction history utilized deceitful contracts. The one or more processors may be further configured to associate an indicator with the digital component if each of the factors is negative.

Yet another aspect of the disclosure is directed to a non-transitory computer-readable medium storing instructions, which when executed by one or more processors, cause the one or more processors to receive, from a wallet owner, authorization to access a transaction history of a digital wallet, wherein the wallet owner is associated with the digital component; and determine, based on the transaction history, factors. The factors may comprise whether a party to one or more transactions of the transaction history is a previously identified decoy, and whether one or more transactions of the transaction history utilized deceitful contracts. The one or more processors may be further configured to associate an indicator with the digital component if each of the factors is negative.

### BRIEF DESCRIPTION OF THE DRAWINGS

FIG. 1 is a screenshot illustrating an example output of digital components according to aspects of the disclosure.

FIG. 2 is a sequence diagram according to aspects of the disclosure.

FIG. 3 is an example transaction history of a wallet owner according to aspects of the disclosure.

FIG. 4 is an example transaction history associated with a virtual good according to aspects of the disclosure.

FIG. 5 is another sequence diagram according to aspects of the disclosure.

FIG. 6 is an example transaction history associated with another virtual good according to aspects of the disclosure.

FIG. 7 is another sequence diagram according to aspects of the disclosure.

FIG. 8 is a functional diagram illustrating an example system according to aspects of the disclosure.

FIG. 9 is a flow diagram illustrating an example method of associating an indicator with a digital component according to aspects of the disclosure.

### DETAILED DESCRIPTION

The technology is generally directed to providing an indication signifying whether a merchant associated with a digital component has been verified. The digital component may be, for example, an advertisement for the sale of a virtual good, such as a non-fungible token (“NFT”) or other digital asset. The indication may be an indicator, such as an icon, conspicuously positioned on a portion of the digital component to alert users that the merchant associated with the digital component has been verified and/or the virtual good within the digital component has been verified. In some examples, the indication may alert users that the merchant associated with the digital component is the owner of the virtual good. The indication may be displayed if a threshold number of criteria are met, including whether the merchant has transacted with decoys, whether the transactions of the merchant utilized deceitful contracts. According to some examples, the indication may be displayed only if all the criteria are met. The decoys may be, for example, scammers, and deceitful contracts may be contracts other than smart contracts. According to some examples, the indication may, additionally or alternatively, be displayed after determining that the virtual good has not been created, owned, or sold by someone associated a decoy wallet and/or created, owned, or sold using a deceitful contract.

Verification of the merchant associated with the digital component may provide a comprehensive determination of whether the merchant is safe to transact with, addressing aspects of security and potential vulnerabilities when entering into a transaction with the merchant. Moreover, from the user's perspective, deciding whether a merchant is safe, and whether to therefore proceed with entering a transaction with the merchant, is greatly simplified. Rather than trying to decipher a broad range of indicia with many different meanings, the user may simply defer to the verification indicator. The indicator, therefore, provides reliable and unbiased information about the goods or the merchant to the user, based on actual fraudulent transactions.

Verification of the virtual good, in addition to or as an alternative of verification of the merchant, may provide a comprehensive determination of whether the virtual good is what it purports to be. For example, the verification process may address aspect of security and vulnerabilities when entering into a transaction for the virtual good by ensuring that the contracts used are smart contracts. Further, the verification process may ensure that the virtual good has been created, sold, and purchased by verified users, e.g., merchants, using smart contracts. When the verification indictor stipulates an unreliable merchant or good, the corresponding good, merchant, or digital component may be removed from an auction system, or simply not presented in a user interface to a user.

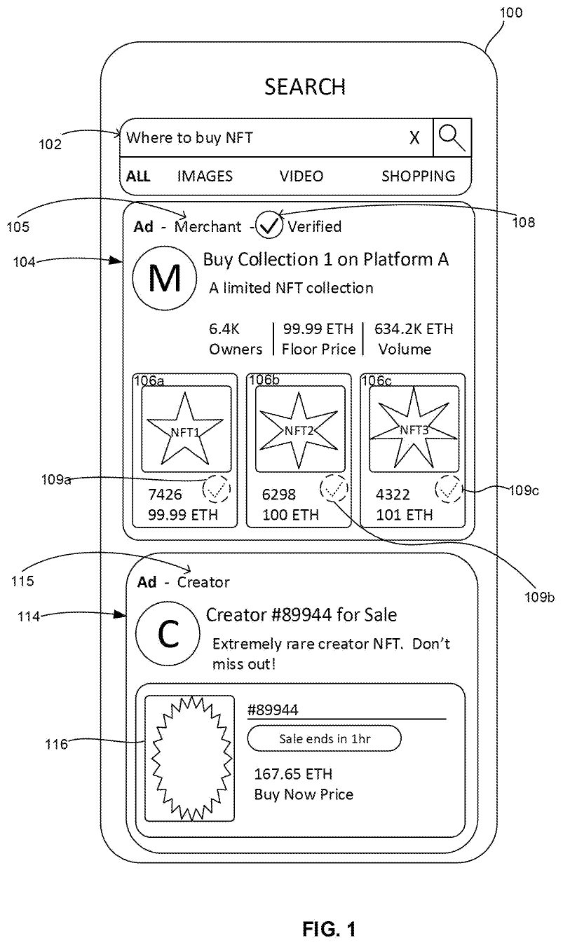

FIG. 1 illustrates example digital components that may be provided for output by a publisher. The publisher may be, for example, a content provider. The content may be a website, mobile and/or computer application, or the like. The digital components 104, 114 may be provided alongside and/or in addition to content being published by the publisher.

As shown in FIG. 1, the publisher may receive a search request 102 for “where to buy NFTs” from device 100. In response to the search request 102, the publisher may retrieve relevant content related to the search request 102. According to some examples, in response to receiving the search request 102, the publisher may transmit a request for one or more digital components 104, 114 to an ad server. The digital components 104, 114 may be related to the search request 102.

The ad server may identify one or more digital components, such as ads, that are relevant to the search request 102. The digital components 104, 114 may include an indicator 108 when the merchant and/or virtual good associated with the digital component 104, 114 have been verified. For example, the ad server may determine whether the merchant fulfills certain criteria before the ad server verifies the merchant. The merchant may have to fulfill a threshold number of criteria to be verified. In some examples, the merchant may have to fulfill all the criteria before being verified. The criteria for verifying the merchant may include, for example, whether, based on the transaction history of the merchant, the merchant has transacted with any known decoys, whether the merchant has utilized deceitful contracts, etc. In some examples, verifying the merchant may include verifying the parties the merchant has transacted with. If the determination of each criteria is negative, e.g., the merchant has not transacted with known decoys, the merchant has not utilized deceitful contracts, the parties the merchant has transacted with have not transacted with known decoys, the parties the merchant transacted with have not utilized deceitful contracts, etc., the merchant may be verified.

In some examples, the ad server may determine whether the virtual good associated with the digital component fulfills certain criteria before the ad server verifies the virtual good. The criteria for verifying the virtual good may include, for example, whether, based on the transaction history of the virtual good, any of the parties to the transactions are known decoys, whether any of the transactions utilized deceitful contracts, etc. If the determination of each criteria is negative, e.g., none of the parties to the transactions associated with the virtual good are known decoys and none of the transactions associated with the virtual good utilized deceitful contracts, the virtual good may be verified. According to some examples, the virtual good may have to fulfill a threshold number of criteria before being verified. In another example, the virtual good may have to fulfill all the criteria before being verified.

The ad server may associate an indicator with the digital component when the merchant and/or virtual good has been verified. The virtual goods may be verified individually such that the merchant may be verified with respect to one virtual good but not with respect to another. For example, if a party in the transaction history associated with the virtual good is not verified, the virtual good may not be verified even if the merchant is verified. However, this may not prevent other virtual goods offered by the merchant from being verified. Thus, the verification process provides a case-by-case basis, that considers the merchant and the virtual good. The merchant therefore may be able to provide digital components that include an indication that the merchant and/or virtual good has been verified for some virtual goods offered by the merchant but not others.

The indicator may provide an indication 108 that a comprehensive determination of whether the merchant is safe to transact with has been completed and the merchant has been deemed safe. In some examples, the indicator 109a-109c may provide an indication that a comprehensive determination of whether the virtual good is safe to transact with has been completed and the virtual good has been deemed safe.

In response to the request for one or more digital components, the ad server may return digital components 104, 114 to the publisher for output. Digital component 104 includes indicator 108, thereby providing an indication that the merchant 105 and/or virtual goods 106-106c associated with digital component 104 have been verified. Digital component 114 does not include an indication, thereby indicating that either the merchant 115 and/or virtual good 116 could not be verified.

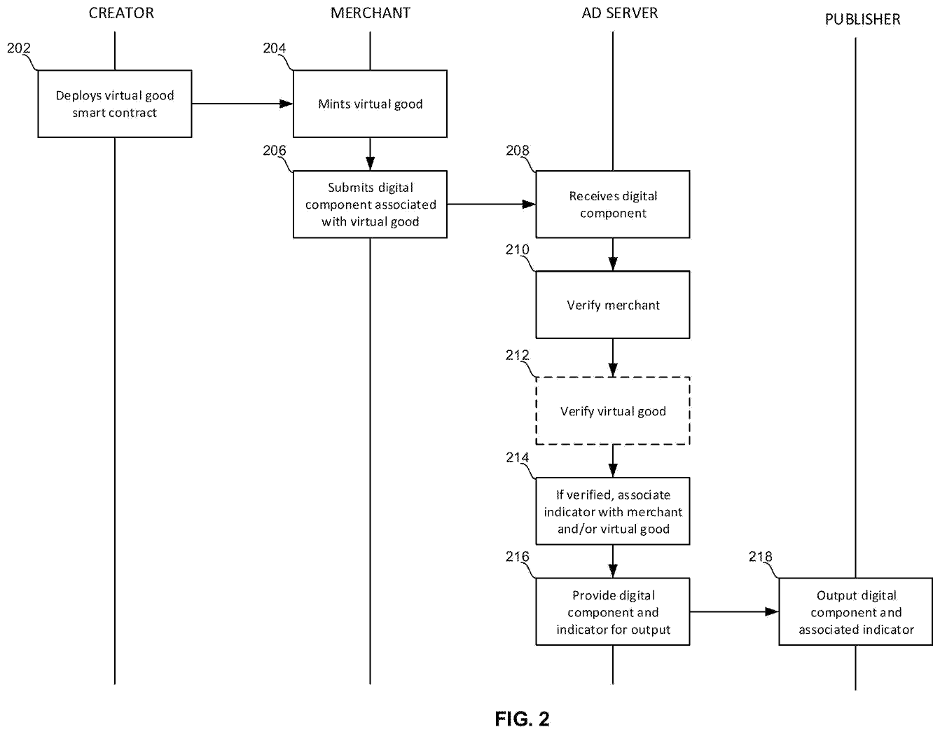

FIG. 2 is an example sequence diagram of steps that occur among a creator, merchant, and ad server. The following operations do not have to be performed in the precise order described below. Rather, various operations can be handled in a different order or simultaneously, and operations may be added or omitted.

In block 202, the creator may deploy a smart contract for a virtual good. The virtual good may be, for example, a virtual good intended to be added to the blockchain such that the virtual good is associated with a digital wallet as the virtual good is bought and sold. According to some examples, the virtual good may be an NFT or other digital asset.

In block 204, the merchant may mint the virtual good such that the virtual good is added to the blockchain. Once the virtual good is on the blockchain, the ownership of the virtual good may be associated with a digital wallet. The merchant may be, for example, an individual user, a brand, a creator of the virtual good, a marketplace selling the virtual good, the owner of the virtual good, or the like. The merchant may be the owner of the digital wallet that the virtual good is associated with. After the virtual good is added to the blockchain, the virtual good may be bought and sold by merchants via a marketplace, personal sales, or the like.

In block 206, the merchant may submit a digital component to the ad server. The digital component may be associated with or related to the virtual good. For example, the digital component may be an advertisement for the sale of the virtual good. In some examples, the digital component may be for a plurality of virtual goods, such as when the virtual good is part of a collection of virtual goods. According to some examples, when the merchant submits the digital component, the digital component may be part of an advertising campaign. In some examples, when the merchant submits the digital component, the merchant may include a bid strategy.

In block 208, the ad server may receive the digital component. The ad server may store the digital component in an ad server storage system.

In block 210, the ad server may verify the merchant. For example, the ad server, or another part of the system in communication with the ad server, may verify the merchant and/or ownership of the virtual good based on the transaction history associated with the merchant. According to some examples, the ad server may verify the merchant after meeting certain criteria or fulfilling certain factors. The factors may include, for example, whether a party of one of the transactions in the merchant's transaction history is a previously identified decoy, whether one of the transactions utilized deceitful contracts, etc. If each criteria, or factor, is negative, the merchant may be verified.

The transaction history may be stored in a digital wallet and/or accessible via the blockchain. The transaction history of the digital wallet may be used after the digital wallet owner authorizes the ad server, or system, to access or receive the wallet address. For example, the system may transmit a request to the owner of the digital wallet, e.g., the merchant associated with the virtual good, to receive authorization to access the wallet address. After the ad server receives access to the wallet address, the ad server may use the wallet address to access the transaction history of the digital wallet.

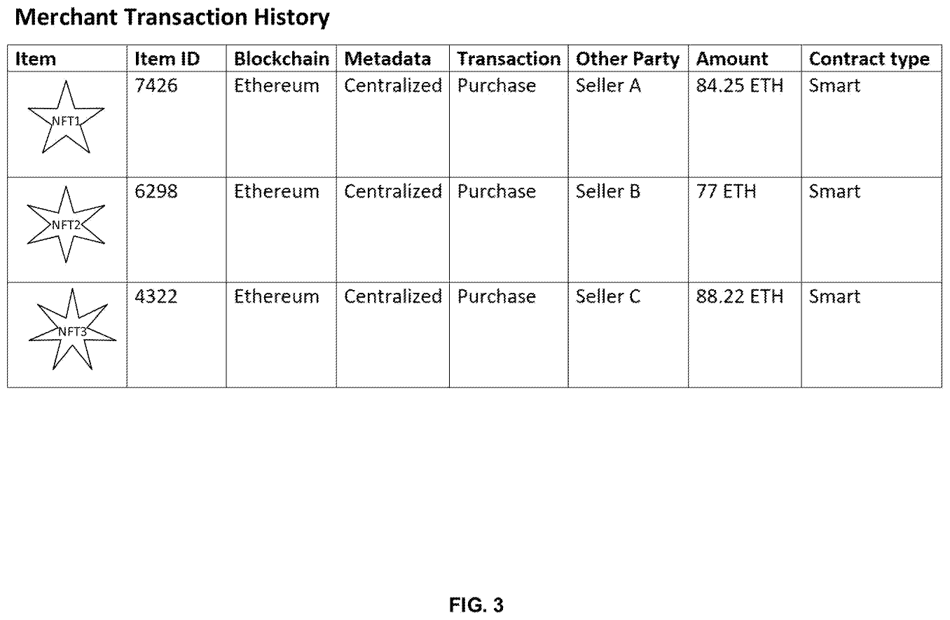

FIG. 3 illustrates an example transaction history of the digital wallet of the merchant. As shown, the merchant was the purchaser of Item IDs 7426, 6298, and 4322. The transaction history may identify, for example, the blockchain used for the transaction, whether the metadata associated with the transaction is centralized or not, whether they purchased or sold the Item, the identity of the other party to the transaction, the value of the transaction, the type of contract used for the transaction, etc.

When access to the transaction history of the digital wallet is authorized by the owner of the digital wallet, the system may identify one or more parties to the transactions other than the wallet owner. The other parties may include, for example, the smart contract owner and/or developer, previous owners of the virtual good, or the like. The identified parties may be third parties to the transactions, such as a party buying a virtual good from the wallet owner or a party selling the wallet owner a virtual good. The identified parties may be associated with an identifier, such as a wallet identifiers (“IDs”). The wallet IDs may be used to determine whether the wallet owner has transacted with a known decoy. The decoy may be, for example, a known scammer. A known scammer may be a user that has been associated with phishing attempts to obtain sensitive information and/or digital currency, producing and selling counterfeit virtual goods, operating a fake or knockoff version of a known marketplace, rug pulls, or the like. Rug pulls may be, for example, an offer for a future reward after the purchase of a virtual good.

The wallet IDs associated with the decoys may be stored in a database. The system may compare the wallet IDs of the identified parties to the transactions to the database of wallet IDs of known decoys. If there is a match between the wallet IDs associated with the transactions and a wallet ID of a known decoy, the system may determine that the wallet owner has transacted with a known decoy.

When access to the transaction history of the digital wallet is authorized by the owner of the digital wallet, the system may identify a type of contract used in the respective transactions. The contract may be, for example, a smart contract that allows for transactions between the wallet owner and another party to buy or sell a virtual good. The smart contracts may, in some examples, be deceitful contracts. Deceitful contracts may be smart contracts where one or more contract functions have been altered. Altered contract functions may provide the wallet owner or the other party to the contract more rights than one of the parties to the contract intended. For example, an altered contract function of “SetApprovalforAll” in a transaction other than listing the virtual good may provide an unknown open-ended agreement granting access to all virtual goods within the digital wallet. In another example, an altered contract function of “SafeTransferForm” in a transaction other than the wallet owner transferring their virtual good to another wallet they own may allow for the transfer of the virtual good out of the target wallet. The deceitful contracts may, in some examples, be referred to as scam contracts intended to scam a part of the contract out of their virtual goods. Additionally or alternatively, deceitful contracts may be referred to as malicious contracts. Deceitful, scam, and/or malicious contracts may be contracts that are known to trick users into buying, selling, providing monetary compensation, or the like by imitating other services and/or products to obtain unauthorized access to the user's wallet.

The system may compare the contracts associated with the respective transactions to smart contracts. When the contract does not correspond to a smart contract, the contract may be identified as a deceitful contract. In some examples, comparing the contracts to smart contracts may include, for example, comparing the contract functions within the contracts to a safe contract function for the type of transaction. The safe contract function may be a contract function that is not intended to deceive a party to the transaction out of a virtual good.

The wallet owner may be verified based on the determination of whether one or more transactions are with a known decoy and whether one or more transactions utilized deceitful contracts. If the determination for each is negative, e.g., the wallet owner has not transacted with known decoys and the wallet owner has not utilized deceitful contracts, then an indicator may be associated with the digital content submitted by the wallet owner. The indicator may be an indication corresponding to the verification of the wallet owner. The indication may signify that the digital component is being provided by a verified wallet owner and, therefore, can be trusted.

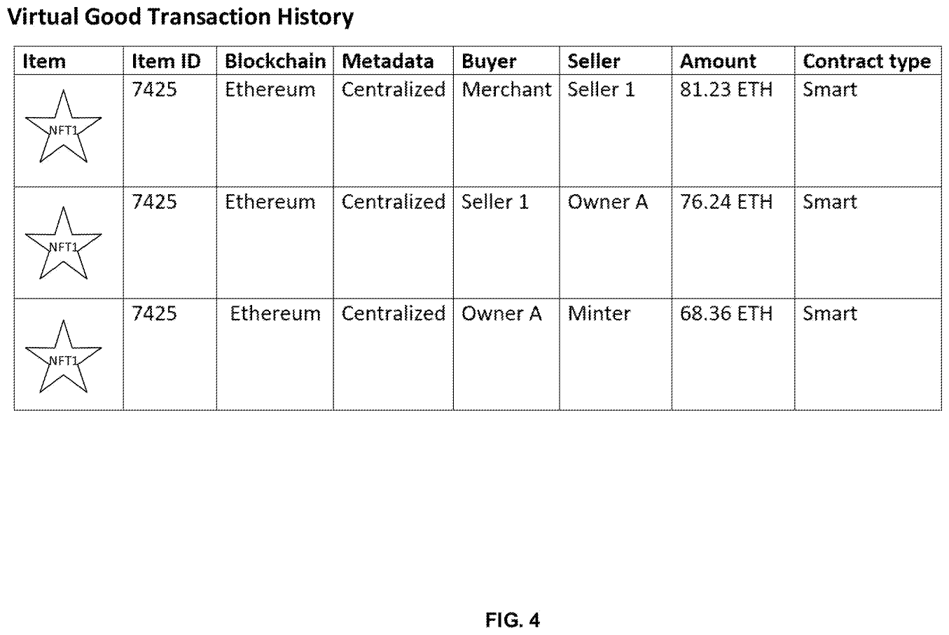

According to some examples, the system may verify whether the wallet owner is the owner of the virtual good. The system may verify the ownership of the virtual good based on the transaction history of the digital wallet. In some examples, the ad server may verify the ownership of the virtual good based on the blockchain associated with the virtual good. For example, when verifying the ownership of the virtual good based on the transaction history, the system may parse the transaction history to identify the transaction(s) associated with the digital good, such as the transaction history associated with Item ID 7426 illustrated in FIG. 4. Once the relevant transactions are identified, the system may identify the parties to the transaction and the type of contract used in the transaction. Based on the parties to the transaction and the type of contract, the system may determine whether the wallet owner obtained the virtual good in a legitimate fashion, e.g., it was not obtained as part of a scam.

In some examples, the system may verify the ownership of the virtual good by crawling the blockchain to identify the transactions associated with the virtual good. The system may compare the wallet IDs identified on the blockchain associated with the virtual good to the wallet ID of the wallet owner. If the last wallet ID on the blockchain for the virtual good is the same as the wallet ID of the wallet owner, the system may determine that the ownership of the virtual good has been verified.

The ad server, or another part of the system, use each factor to determine whether to verify the merchant. The factors may include, for example, whether any of the parties the merchant has bought and sold virtual goods from is a previously known decoy and whether any of the contracts used to buy or sell the virtual goods utilized deceitful contracts. When each of the factors are negative, the merchant may be verified. For example, the ad server may verify the merchants when none of the parties of the transactions in the transaction history are a known decoy and no deceitful contracts were used.

According to some examples, when verifying the merchant, the ad server may identify one or more online accounts associated with the merchant. The online accounts may be, for example, social media accounts. The ad server may determine whether the associated online accounts have been verified. The verification status of the online accounts may be used as another factor when verifying the merchant. For example, if the associated online accounts have been verified, the merchant may be more likely to be verified. However, if there are no verified online accounts associated with the merchant, the ad server may rely on other facts when verifying the merchant.

Returning to FIG. 2, in block 212 the ad server may, in some examples, verify the virtual good. Verifying the virtual good may include, for example, verifying the transactions associated with the virtual good and the parties associated with those transactions. For example, the ad server may verify the good after meeting certain criteria or fulfilling certain factors. The factors may include, for example, whether a party to one of the transactions associated with the virtual good is a previously identified decoy, whether one of the transactions associated with the virtual good utilized deceitful contracts, etc. If each criteria, or factor, is negative, the virtual good may be verified.

Referring to FIG. 4, a transaction history for Item ID 7425 is illustrated. The transaction history may include an indication of the blockchain used for the transactions associated with the virtual good, how the metadata is stored and/or available, the wallet ID of the buyer and seller of the virtual good, the transaction amount for each transaction, the type of contract used for each transaction, etc.

The ad server, or another part of the system in communication with the ad server, may verify the buyer and seller of each transaction for the virtual good. The ad server may verify the buyer and seller of the transactions similar to the way the ad server may verify the merchant that submitted the digital component. For example, the ad server, or another part of the system, may compare the wallet IDs associated with the buyers and seller to a database of wallet IDs of known decoys. If there is a match between the wallet IDs associated with any one of the buyers or sellers for the virtual good and a wallet ID of a known decoy, the system may determine that the virtual good has been associated with a known decoy. According to some examples, when the virtual good has been associated with a known decoy, the virtual good may not be verified by the ad server.

According to some examples, the ad server, or another part of the system, may identify the type of contract used for each transaction associated with the virtual good. If any one of the transactions used a deceitful contract, the ad server may not verify the virtual good. As shown in FIG. 4, the contracts used for the transactions associated with Item ID 7425 are all smart contracts. Accordingly, based on the types of contracts used, virtual good, e.g., Item ID 7425, may be verified.

The ad server, or another part of the system, use each factor to determine whether to verify the virtual good. The factors may include, for example, whether any of the parties is a previously known decoy and whether any of the contracts used in the transactions associated with the virtual good utilized deceitful contracts. When each of the factors are negative, the virtual good may be verified. For example, the ad server may verify the virtual good when none of the parties of the transactions are a known decoy and no deceitful contracts were used.

In block 214, if the merchant was verified in block 210, an indicator may be associated with the merchant. Additionally or alternatively, in block 214, if the virtual good was verified in block 212, the indicator may be associated with the virtual good. For example, as shown in FIG. 1, an indicator 108 may be associated with merchant 105 of the digital component 104. An indicator 109a-109c may, additionally or alternatively, be associated with each virtual good 106a-106c in the digital component 104 if the virtual good 106a-106 has been verified.

In block 216, the ad server may provide the digital component and associated indicator for output to the publisher. For example, the ad server may receive a request for an advertisement from the publisher. The ad server may solicit bids from the merchants who submitted digital components. The merchants may bid on to have their digital component displayed on the publisher's website. According to some examples, the bidding may occur automatically based on the bid strategy the merchants included with the submission of the digital component. After the conclusion of the bidding, the ad server may return the winning digital components to the publisher.

In block 218, the publisher may output the digital component and associated indicator. The digital component may be provided alongside or in addition to the content being output by the publisher. For example, as shown in FIG. 1, the publisher may provide search results in response to a search query 102. The digital component 104 may be provided for output in addition to the search results, not shown. The indicator 108 may be provided for output with the digital component 104, thereby indicating that the merchant 105 and/or virtual good 106a-106c is safe to transact with.

According to some examples, the digital components may be part of an ad campaign. Conversions related to the ad campaign may be determined based on the blockchain. The conversions may be, for example, clicks, views, purchases, or the like associated with the ad campaign.

In examples where the conversions are purchases, the conversions may be determined based on the blockchain for the virtual good. For example, the system may identify the wallet IDs on the blockchain associated with the virtual good in a given ad campaign. The wallet IDs may be associated with an ad preference profile. The ad preference profile may identify subjects, topics, types of goods or services, etc. that the wallet owner has an interest in. According to some examples, the ad preference profile may be determined based on the virtual goods and/or characteristics of the virtual goods that are part of the wallet owner's transaction history. The system may use the ad preference profile associated with wallet IDs to identify relevant ad campaigns to output to the wallet owner.

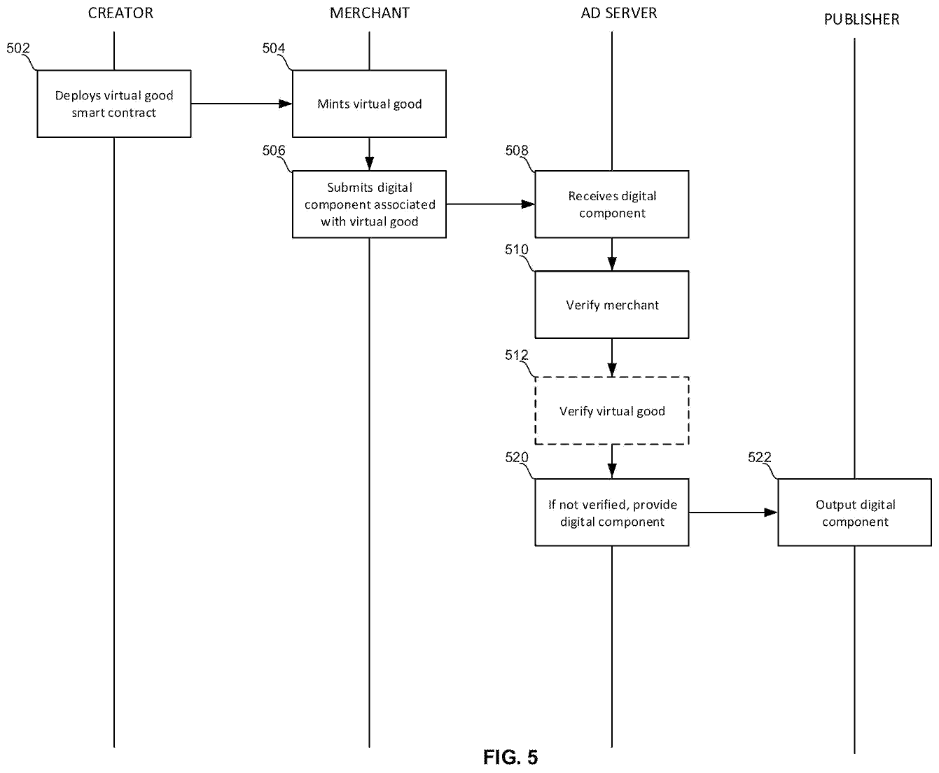

FIG. 5 is an example sequence diagram of steps that occur among a creator, merchant, and ad server. The following operations do not have to be performed in the precise order described below. Rather, various operations can be handled in a different order or simultaneously, and operations may be added or omitted. FIG. 5 is substantially similar to FIG. 2 but differs in that the merchant and/or virtual good has not been verified.

The creator, in block 502, may deploy a smart contract for a virtual good. The merchant, in block 504, may mint the virtual good such that the virtual good is added to the blockchain. The merchant may, in block 506, submit a digital component to an ad server. The digital component may be associated with the virtual good that was minted in block 504. The ad server may, in block 508, receive the digital component from the merchant.

In block 510, the ad server may verify the merchant. Verifying the merchant may include, for example, verifying that the merchant is the owner of the virtual good associated with the digital component. The merchant may be verified after the merchant meets and/or fulfills certain criteria. The criteria may be based on the merchant's transaction history, including the users the merchant has transacted with and the types of contracts used in the transactions. For example, the criteria may include whether a party the merchant has previously transacted with is a previously identified or known decoy, whether one of the transactions utilized deceitful contracts, etc. If each factor is negative, the merchant may be verified. The factors may be determined as described above with respect to FIGS. 2 and 3.

In block 512, the ad server may verify the virtual good associated with the digital component. Verifying the virtual good may include, for example, verifying the transactions associated with the virtual good and the parties associated with those transactions. The virtual good may be verified after the virtual good meets and/or fulfills certain criteria. The criteria may include, for example, whether a party to the transactions associated with the virtual good is a previously identified or known decoy, whether one of the transactions associated with the virtual good utilized deceitful contracts, etc. If each factor is negative, the virtual good may be verified.

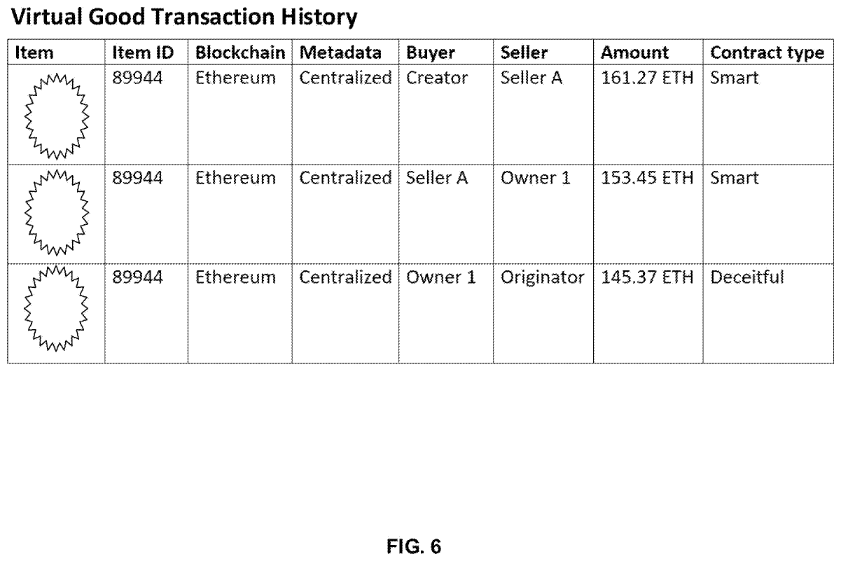

FIG. 6 illustrates a transaction history for Item ID 89944. Item ID 89944 may be the virtual good 116 associated with the digital component 114 for submitted by merchant 115, as shown in FIG. 1. The transaction history shown in FIG. 6 may include an indication of the blockchain used for the transactions associated with the virtual good, how the metadata is stored and/or available, the wallet ID of the buyer and seller of the virtual good, the transaction amount for each transaction, the type of contract used for each transaction, etc.

The ad server, or another part of the system in communication with the ad server, may verify the buyer and seller of each transaction for the virtual good. For example, the ad server may compare the wallet ID of the buyers and sellers to wallet IDs of previously identified decoys, or scammers, to determine if any of the buyers and sellers associated with the virtual good is a known decoy. If any one of the buyers and sellers associated with the virtual good is determined to be a known decoy, the virtual good may not be verified.

The ad server, or another part of the system in communication with the ad server, may verify the types of contracts used for each transaction associated with the virtual good. If any one of the transactions associated with the virtual good used a deceitful contract, the ad server may not verify the virtual good. As shown in FIG. 6, the ad server may determine that the transaction between the seller, “Originator,” and the buyer, “Owner 1,” used a deceitful contract. The use of a deceitful contract at any point during the transaction history of the virtual good may prevent the virtual good from being verified.

In examples where the merchant and/or virtual good is not verified, an indicator may not be associated with the merchant and/or virtual good. For example, as shown in FIG. 1, neither digital component 114 nor virtual good 116 include an indicator identifying that the merchant 115 or virtual good 116 has been verified. This may provide users a quick way to determine that a transaction with the merchant 115 or purchase of the virtual good 116 is not safe.

Returning to FIG. 5, in block 520, the ad server may provide the digital component for output, without an associated indicator. The publisher, in block 522, may output the digital component.

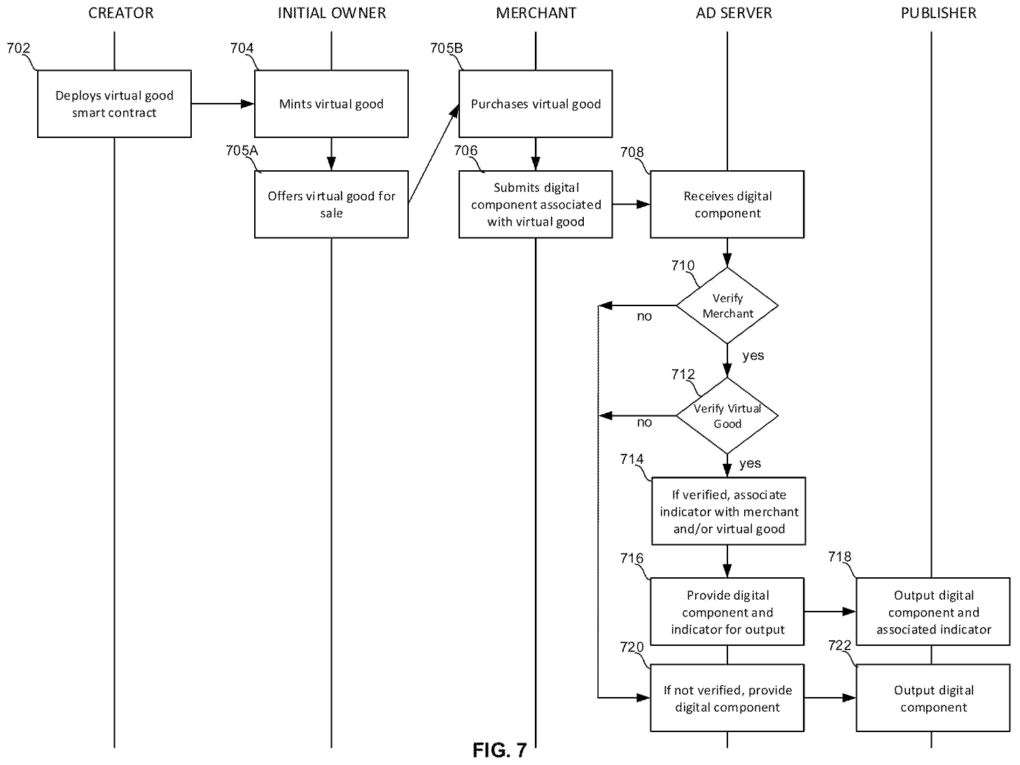

FIG. 7 is an example sequence diagram of steps that occur among a creator, initial owner, merchant, and ad server. The following operations do not have to be performed in the precise order described below. Rather, various operations can be handled in a different order or simultaneously, and operations may be added or omitted. FIG. 7 is substantially similar to FIGS. 2 and 5 but differs in that there is at least one additional transaction associated with the virtual good before the merchant submits the digital component associated with the virtual good to the ad server.

The creator, in block 702, may deploy a smart contract for a virtual good. The initial owner may, in block 704, mint the virtual good such that the virtual good is added to the blockchain.

In block 705A, the initial owner may offer the virtual good for sale. The initial owner may enter into a transaction with a subsequent owner, such as the merchant. For example, in block 705B, the merchant may purchase the virtual good from the initial owner.

The merchant may, in block 706, submit a digital component to an ad server. The digital component may be associated with the virtual good that was minted in block 704. The ad server may, in block 708, receive the digital component from the merchant.

In block 710, the ad server may verify the merchant. The merchant may be verified after the merchant meets and/or fulfills certain criteria. For example, the criteria may include whether a party the merchant has previously transacted with is a previously identified or known decoy, whether one of the transactions utilized deceitful contracts, etc. If each factor is negative, the merchant may be verified. The factors may be determined as described above with respect to FIGS. 2 and 3.

According to some examples, verifying the merchant may further include verifying the previous owners of the virtual good. For example, the ad server, or another part of the system in communication with the ad server, may determine whether the previous owners of the virtual good have previously transacted with known decoys and/or whether the previous owners have utilized deceitful contracts. If each factor for the previous owners is negative and each factor for the merchant is negative, then the merchant may be verified.

In block 712, the ad server may verify the virtual good associated with the digital component. Verifying the virtual good may include, for example, verifying the transactions associated with the virtual good and the parties associated with those transactions. The virtual good may be verified after the virtual good meets and/or fulfills certain criteria. The criteria may include, for example, whether a party to the transactions associated with the virtual good is a previously identified or known decoy, whether one of the transactions associated with the virtual good utilized deceitful contracts, etc. If each factor is negative, the virtual good may be verified.

In block 714, if the merchant and/or virtual good is verified, the ad server may associate an indicator with the digital component. The ad server may, in block 716, provide the digital component and associated indicator to the publisher for output. The publisher may, in block 718, output the digital component and associated indicator.

In block 720, if the merchant and/or virtual good is not verified, the ad server may provide the digital component to the publisher for output, without an associated indicator. In block 722, the publisher may output the digital component.

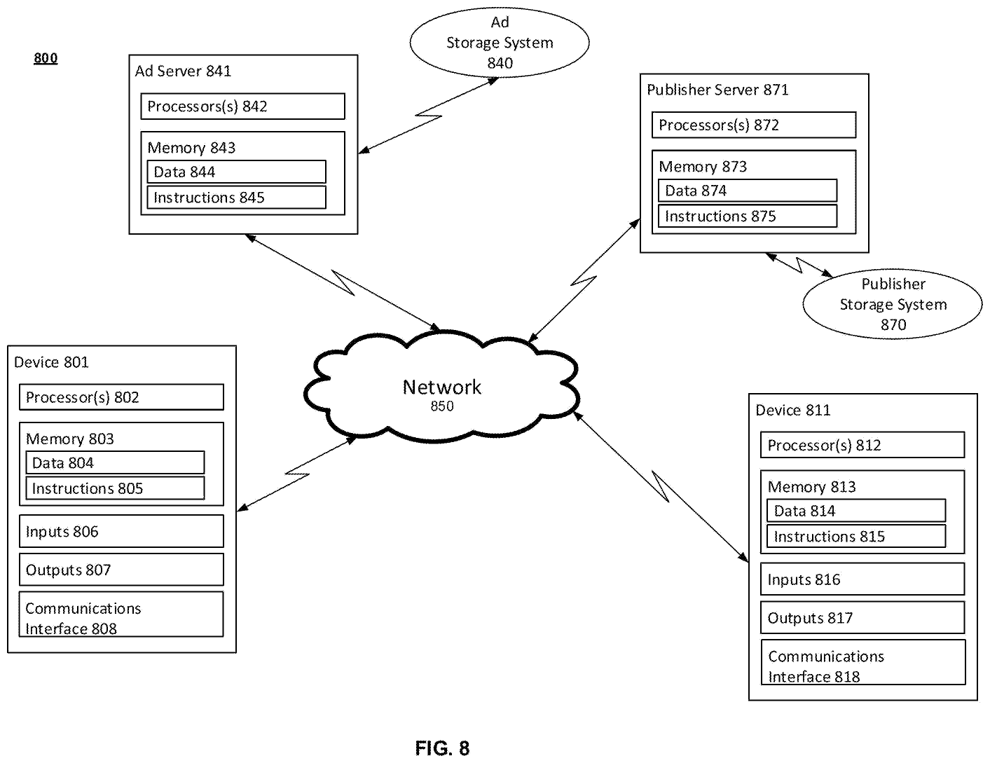

FIG. 8 illustrates an example system in which the features described above and herein may be implemented. It should not be considered as limiting the scope of the disclosure or usefulness of the features described herein. In this example, system 800 includes devices 801, 811, ad servers 841, ad server storage system 840, publisher server 871, publisher storage system 870, and network 850. For purposes of clarity, devices 801, 811 will be described with respect to device 801. However, it should be understood that device 811 may include the same or similar components and may function in substantially the same way.

Device 801 may include one or more processors 802, memory 803, data 804 and instructions 805. Device 801 may also include inputs 806, outputs 807, and a communications interface 808. The devices 801 may be, for example, a smart phone, tablet, laptop, smart watch, AR/VR headset, smart helmet, home assistant, etc.

Memory 803 of device 801 may store information that is accessible by processor 802. Memory 803 may also include data that can be retrieved, manipulated or stored by the processor 802. The memory 803 may be of any non-transitory type capable of storing information accessible by the processor 802, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 803 may store information that is accessible by the processors 802, including instructions 805 that may be executed by processors 802, and data 804.

Data 804 may be retrieved, stored or modified by processors 802 in accordance with instructions 805. For instance, although the present disclosure is not limited by a particular data structure, the data 804 may be stored in computer registers, in a relational database as a table having a plurality of different fields and records, XML documents, or flat files. The data 804 may also be formatted in a computer-readable format such as, but not limited to, binary values, ASCII or Unicode. By further way of example only, the data 504 may comprise information sufficient to identify the relevant information, such as numbers, descriptive text, proprietary codes, pointers, references to data stored in other memories (including other network locations) or information that is used by a function to calculate the relevant data.

The instructions 805 can be any set of instructions to be executed directly, such as machine code, or indirectly, such as scripts, by the processor 802. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 802 may include any conventional processors, such as a commercially available CPU or microprocessor. Alternatively, the processor can be a dedicated component such as an ASIC or other hardware-based processor. Although not necessary, device 501 may include specialized hardware components to perform specific computing functions faster or more efficiently.

Although FIG. 8 functionally illustrates the processor, memory, and other elements of device 801 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of device 801. Accordingly, references to a processor or device will be understood to include references to a collection of processors or devices or memories that may or may not operate in parallel.

The inputs 806 may be, for example, a mouse, keyboard, touch-screen, microphone, or any other type of input. The inputs may receive key words for a search on a publisher's website or mobile application.

Output 807 may be a display, such as a monitor having a screen, a touch-screen, a projector, or a television. The display 807 of the device 801 may electronically display information to a user via a graphical user interface (“GUI”) or other types of user interfaces. For example, display 807 may electronically display product information and sponsored ads on a publisher's website or mobile application.

The devices 801 can be at various nodes of a network 850 and capable of directly and indirectly communicating with other nodes of network 550. Although two devices are depicted in FIG. 8, it should be appreciated that a typical system can include one or more computing devices, with each computing device being at a different node of network 850. The network 850 and intervening nodes described herein can be interconnected using various protocols and systems, such that the network can be part of the Internet, World Wide Web, specific intranets, wide area networks, or local networks. The network 850 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

System 800 may include one or more server computing devices, such as ad server 541 and publisher server 871. The server computing devices may be, for example, a load balanced server farm, that exchange information with different nodes of a network for the purpose of receiving, processing and transmitting the data to and from other computing devices. For instance, ad server 841 and publisher server 871 may be a web server that is capable of communicating with the device 801 via the network 850. In addition, ad server 841 and publisher server 871 may use network 850 to transmit and present information to a user of device 801. Ad server 841 and publisher server 871 may include one or more processors 842, 872, memory 843, 873, data 844, 874, instructions 845, 875, etc. These components operate in the same or similar fashion as those described above with respect to device 801.

Ad server 841 may manage content, such as digital components, and provide various services to the advertisers, publishers, and devices 801. According to some examples, ad server 841 may receive ad campaigns from one or more advertisers, such as merchants or creators or virtual goods. The ad campaigns may include campaign information, such as the virtual goods, bidding strategy, targeting information, duration, information related to the virtual goods, etc. The ad campaigns may be stored in the memory 843 of ad server 841 and/or in ad server storage system 840.

According to some examples, publisher server 871 may receive a search query from device 801. For example, the search query may be for content, such as information related to a virtual good. In response the request, publisher server 871 may retrieve relevant content from publisher storage system 870. The publisher server 871 may transmit a content page or other presentation, representation, or characterization of the content to the requesting device 801. The content page may include, for example, one or more digital components.

According to some examples, in response to the received search query, publisher server 871 may transmit a request for digital components to ad server 841. Ad server 841 may facilitate the identification of relevant digital components for distribution to the publishers.

According to some examples, ad server 841 may verify the merchant and/or virtual good associated with the digital component. The ad server 841 may verify the merchant by determining whether the merchant fulfills certain criteria. For example, the ad server 841 may determine, based on the transaction history of the merchant, whether the merchant has previously transacted with known decoys and whether any of the merchant's previous transactions utilized deceitful contracts. In some examples, when verifying the merchant, the ad server 841 may verify each party the merchant has previously transacted with using the same or similar criteria. If each criteria is negative, the ad server 841 may verify the merchant.

The ad server 841 may, additionally or alternatively, verify the virtual good by determining certain criteria. For example, the ad server 841 may determine, based on the transaction history of the virtual good, whether a party to the transactions associated with the virtual good is a known decoy, whether any of the transactions associated with the virtual good utilized deceitful contracts, etc. If each criteria is negative, the ad server 841 may verify the virtual good.

The ad server 841 may, after verifying the merchant and/or virtual good, associate an indicator with the digital component. The indicator may provide an indication that a comprehensive determination of whether the merchant is safe to transact with has been completed and the merchant has been deemed safe. In some examples, the indicator may provide an indication that a comprehensive determination of whether the virtual good is safe to purchase has been completed and the virtual good has been deemed safe. The indicator may address aspects of security and potential vulnerabilities when entering into a transaction with the merchant. Moreover, the indicator may reduce computational resources by reducing the need for a user to decipher a broad range of indicia with different meaning. This may reduce the bandwidth used by reducing the number of searches to be completed to reach the same conclusion regarding the safety of the merchant and/or virtual good. The indicator may provide an indication that the Device 801 may present in a viewer, such as a browser, mobile application, or other content display system, the search query results integrated with one or more of the digital components provided by the ad server 841. In examples where the merchant and/or virtual good associated with the digital components has been verified, the digital component provided by the ad server 841 may include an indicator of the verification status of the merchant and/or virtual good.

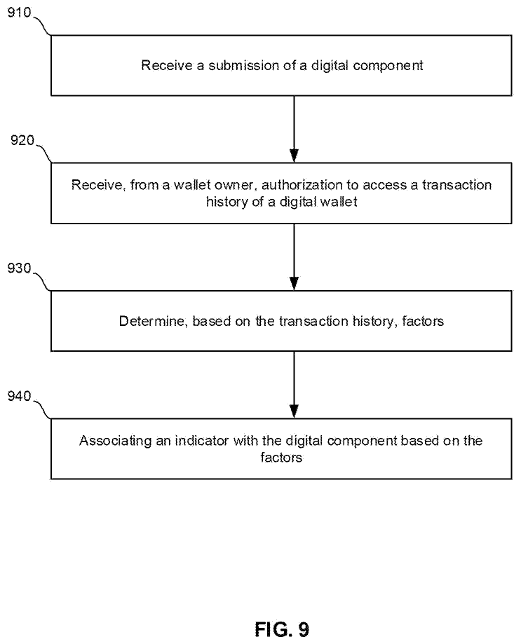

FIG. 9 illustrates an example method for associating an indicator with a digital component. The following operations do not have to be performed in the precise order described below. Rather, various operations can be handled in a different order or simultaneously, and operations may be added or omitted.

In block 910, a submission of a digital component may be received. The submission may be received by, in some examples, an ad server. The digital component may be an advertisement. The digital component may be related to or associated with a virtual good. The virtual good may be, for example, a non-fungible token or other digital asset.

In block 920, authorization to access a transaction history of a digital wallet may be received from a wallet owner. For example, the ad server may receive the wallet address associated with the wallet owner. The wallet owner may be associated with the digital component. For example, the wallet owner may be the owner or seller of the virtual good associated with the digital component.

In block 930, one or more factors may be determined based on the transaction history of the wallet owner. The factors may include, for example, whether a party to one or more transactions of the transaction history is a previously identified decoy and whether one or more transactions of the transaction history utilized deceitful contracts.

Determining whether a party to the one or more transactions is a previously identified decoy may include identifying an identity of a party to the respective transaction other than the wallet owner and determining, based on the identified identity of the party, whether the party corresponds to one or more previously identified decoys. For example, the identity of the party other than the wallet owner may be compared to a database of known and/or previously identified decoys.

Determining whether the one or more transactions utilized deceitful contracts may include, for example, determining one or more types of contracts utilized during the transactions and comparing the determined types of contracts to smart contracts. When the type of contract does not correspond to a smart contract, the contract may be identified as a deceitful contract.

In block 940, an indicator may be associated with the digital component based on the factors. According to some examples, the indicator may be associated with the digital component if each of the factors is negative. For example, if none of the parties to the transactions of the transaction history is a previously identified decoy and none of the transactions of the transaction history utilized deceitful contracts, an indicator may be associated with the digital component. The indicator may signify that the wallet owner has been verified. The digital component and associated indicator may be provided for output.

In some examples, another fact may include the verification of the parties the wallet owner has transacted with. The verification of each party may be similar to the verification of the wallet owner. For example, a number of factors for each party may be determined, including whether the party has transacted with a previously identified decoy and whether the party has utilized deceitful contracts.

According to some examples, the ownership of the digital component may be verified. Verifying the ownership of the digital component may include identifying, based on the transaction history, an owner of the digital component and comparing the owner of the digital component to the wallet owner.

In some examples, the virtual good associated with the digital component may be verified. The virtual good may be verified based on one or more factors. The factors may include whether a party to a transaction associated with the virtual good corresponds to a previously identified decoy and whether a contract utilized during a transaction associated with the virtual good is a deceitful contract. An indicator may be associated with the virtual good and, therefore, the digital component when each of the factors is negative.

Verification of the wallet owner, e.g., the merchant, associated with the digital component may provide a comprehensive determination of whether the merchant is safe to transact with. For example, the indicator associated with the digital component may alert users that a comprehensive determination regarding the merchant has been made and the merchant is safe to transact with. This may address aspect of security and potential vulnerabilities when transacting with merchants for virtual goods. Further, verification of the virtual good may provide a comprehensive determination of whether the virtual good is what it purports to be and that the virtual good is safe to transact with. For example, the indicator associated with the virtual good may alert users that a comprehensive determination regarding the virtual good has been made and the virtual good is legitimate, e.g., not a fake, and is safe to transact with. This may address aspects of security and potential vulnerabilities when purchasing virtual goods.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A method, comprising:
receiving, by one or more processors, a submission of a digital component;
receiving, by the one or more processors from a wallet owner, authorization to access a transaction history of a digital wallet, wherein the wallet owner is associated with the digital component;
determining, by the one or more processors based on the transaction history, factors comprising:
whether a party to one or more transactions of the transaction history is a previously identified decoy, and
whether one or more transactions of the transaction history utilized deceitful contracts; and
associating, by the one or more processors based on the factors, an indicator with the digital component.

2. The method of claim 1, further comprising providing, by the one or more processors, the digital component and associated indicator for output.

3. The method of claim 1, wherein when determining whether the one or more transactions of the transaction history is the previously identified decoy, the method further comprises:
identifying, by the one or more processors, an identity of a party to the respective transaction other than the wallet owner; and
determining, based on the identified identify of the party, whether the party corresponds to one or more previously identified decoys.

4. The method of claim 1, wherein when determining whether the one or more transactions utilized deceitful contracts, the method further comprises:
determining, by the one or more processors, one or more types of contracts; and
comparing, by the one or more processors, the determined one or more types of contracts to smart contracts, wherein when a type of contract does not correspond to a smart contract, the type of contract is a deceitful contract.

5. The method of claim 1, further comprising verifying, by the one or more processors based on the transaction history, ownership of the digital component.

6. The method of claim 5, wherein verifying ownership of the ownership digital component includes:
identifying, by the one or more processors based on the transaction history, an owner of the digital component; and
comparing, by the one or more processors, the identified owner and the wallet owner.

7. The method of claim 1, wherein the digital component is an advertisement related to a non-fungible token.

8. The method of claim 1, wherein the indicator signifies that the wallet owner has been verified.

9. A system, comprising,
one or more processors, the one or more processors configured to:
receive a submission of a digital component;
receive, from a wallet owner, authorization to access a transaction history of a digital wallet, wherein the wallet owner is associated with the digital component;
determine, based on the transaction history, factors comprising:
whether a party to one or more transactions of the transaction history is a previously identified decoy, and
whether one or more transactions of the transaction history utilized deceitful contracts; and
associate an indicator with the digital component based on the factors.

10. The system of claim 9, wherein the one or more processors are further configured to provide the digital component and associated indicator for output.

11. The system of claim 9, wherein when determining whether the one or more transactions of the transaction history is the previously identified decoy, the one or more processors are further configured to:
identify an identity of a party to the respective transaction other than the wallet owner; and
determine, based on the identified identify of the party, whether the party corresponds to one or more previously identified decoys.

12. The system of claim 9, wherein when determining whether the one or more transactions utilized deceitful contracts, the one or more processors are further configured to:
determine one or more types of contracts; and
compare the determined one or more types of contracts to smart contracts, wherein when a type of contract does not correspond to a smart contract, the type of contract is a deceitful contract.

13. The system of claim 9, wherein the one or more processors are further configured to verify, based on the transaction history, ownership of the digital component.

14. The system of claim 13, wherein when verifying ownership of the ownership digital component, the one or more processors are further configured to:
identify, based on the transaction history, an owner of the digital component; and
compare the identified owner and the wallet owner.

15. The system of claim 9, wherein the digital component is an advertisement related to a non-fungible token.

16. The system of claim 9, wherein the indicator signifies that the wallet owner has been verified.

17. A non-transitory computer-readable medium storing instructions, which when executed by one or more processors, cause the one or more processors to:
receive a submission of a digital component;
receive, from a wallet owner, authorization to access a transaction history of a digital wallet, wherein the wallet owner is associated with the digital component;
determine, based on the transaction history, factors comprising:
whether a party to one or more transactions of the transaction history is a previously identified decoy, and
whether one or more transactions of the transaction history utilized deceitful contracts; and
associate an indicator with the digital component based on the factors.

18. The non-transitory computer-readable medium of claim 17, wherein the instructions, when executed by the one or more processors, cause the one or more processors to provide the digital component and associated indicator for output.

19. The non-transitory computer-readable medium of claim 17, wherein when determining whether the one or more transactions of the transaction history is the previously identified decoy, the instructions, when executed by the one or more processors, cause the one or more processors to:
identify an identity of a party to the respective transaction other than the wallet owner; and
determine, based on the identified identify of the party, whether the party corresponds to one or more previously identified decoys.

20. The non-transitory computer-readable medium of claim 17, wherein when determining whether the one or more transactions utilized deceitful contracts, the instructions, when executed by the one or more processors, cause the one or more processors a to:
determine one or more types of contracts; and
compare the determined one or more types of contracts to smart contracts, wherein when a type of contract does not correspond to a smart contract, the type of contract is a deceitful contract.
